(19) United States
(12) Patent Application Publication
(10) Pub. No.: US 2019/0361428 A1
(43) Pub. Date: Nov. 28, 2019

(54) COMPETENCY GAP IDENTIFICATION OF AN OPERATORS RESPONSE TO VARIOUS PROCESS CONTROL AND MAINTENANCE CONDITIONS

(71) Applicant: Honeywell International Inc., Morris Plains, NJ (US)

(72) Inventors: Ramakrishnan Ganapathi, Bangalore (IN); Prangya Priyadarsini, Bangalore (IN); Viraj Srivastava, New Delhi (IN); Anand Narayan, Bangalore (IN); Subhan Dudekula, Kurnool (IN)

(21) Appl. No.: 15/987,542

(22) Filed: May 23, 2018

(51) Int. Cl. G05B 19/418; G06Q 10/06

(52) U.S. Cl. CPC G05B 19/41865; G05B 2219/25419; G05B 19/41875; G06Q 10/063116

(57) ABSTRACT

A method, an electronic device and computer readable medium is provided. The method includes information associated with operational changes by personnel that operate an industrial plant. The method also includes identifying episodes of the operational changes, wherein each episode includes a triggering event and operational changes. The method also includes generating a causal pairing matrix that categorizes the identified episodes into a plurality of groupings, based on the triggering event of each of the at least two episodes being similar. The method further includes analyzing the at least two episodes to identify one of the at least two episodes as a bench mark episode, within each group. The method also includes comparing each of the at least two episodes to the identified bench mark episode to rank the at least two episodes, within each of the groups. The method further includes generating a report for the plurality of groupings.

### TECHNICAL FIELD

This disclosure relates generally to industrial process control and automation systems. More specifically, this disclosure relates to an apparatus and method for identifying skills levels and knowledge gaps of personnel to improve the efficiency of an industrial plant.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human operators routinely interact with controllers and other devices in a control and automation system, such as to review warnings, alarms, or other notifications and make adjustments to control or other operations. When a human operator responds incorrectly by performing multiple incorrect solutions to an alarm or warning the overall efficiency of a plant deteriorates.

### SUMMARY

This disclosure provides an apparatus and method for automatic contextualization and issue resolution related to an industrial process control and automation system.

In a first embodiment, a method is provided. The method includes collecting information associated with operational changes by personnel that operate an industrial plant. The method also includes identifying episodes of the operational changes, wherein each episode includes a triggering event and the operational changes performed by each of the personnel in response to the triggering event. The method also includes generating a causal pairing matrix that categorizes the identified episodes into a plurality of groupings, wherein each groups includes at least two episodes that are related based on the triggering event of each of the at least two episodes being similar. The method also includes analyzing the at least two episodes to identify one of the at least two episodes as a bench mark episode, within each of the groups. The method further includes comparing each of the at least two episodes to the identified bench mark episode to rank the operational changes performed by each of the personnel of the at least two episodes, within each of the groups. The method also includes generating a report for the plurality of groupings, wherein the report indicates the rank of the at least two episodes in each of the groups.

In a second embodiment, an electronic device is provided. The electronic device includes a receiver and a processor. The receiver is configured to collecting information associated with operational changes by personnel that operate an industrial plant. The processor is operably coupled to the receiver. The processor is also configured to identify episodes of the operational changes, wherein each episode includes a triggering event and the operational changes performed by each of the personnel in response to the triggering event. The processor is also configured to generate a causal pairing matrix that categorizes the identified episodes into a plurality of groupings, wherein each groups includes at least two episodes that are related based on the triggering event of each of the at least two episodes being similar. The processor is also configured to within each of the groups, analyze the at least two episodes to identify one of the at least two episodes as a bench mark episode. The processor is also configured to compare each of the at least two episodes to the identified bench mark episode to rank the operational changes performed by each of the personnel of the at least two episodes, within each of the group. The processor is further configured to generate a report for the plurality of groupings, wherein the report indicates the rank of the at least two episodes in each of the groups.

In a third embodiment, a non-transitory computer readable medium is provided. The non-transitory computer readable medium embodying a computer program, the computer program comprising computer readable program code that when executed by a processor of an electronic device causes processor to collect information associated with operational changes by personnel that operate an industrial plant; identify episodes of the operational changes, wherein each episode includes a triggering event and the operational changes performed by each of the personnel in response to the triggering event; generate a causal pairing matrix that categorizes the identified episodes into a plurality of groupings, wherein each groups includes at least two episodes that are related based on the triggering event of each of the at least two episodes being similar; analyze the at least two episodes to identify one of the at least two episodes as a bench mark episode, within each of the groups; compare each of the at least two episodes to the identified bench mark episode to rank the operational changes performed by each of the personnel of the at least two episodes, within each of the groups; and generate a report for the plurality of groupings, wherein the report indicates the rank of the at least two episodes in each of the groups.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example computing device for competency assessment according to this disclosure;

FIG. 3 illustrates an example block diagram of a communication system according to this disclosure;

FIG. 4 illustrates an example competency assessment diagram according to this disclosure;

FIG. 5 illustrates an example response log according to this disclosure;

FIGS. 6A-D illustrate example graphical response logs according to this disclosure;

FIG. 7 illustrates an example field report according to this disclosure;

FIG. 8 illustrates an example maintenance log according to this disclosure; and

FIG. 9 illustrates a method for identifying skill level of personnel according to this disclosure.

### DETAILED DESCRIPTION

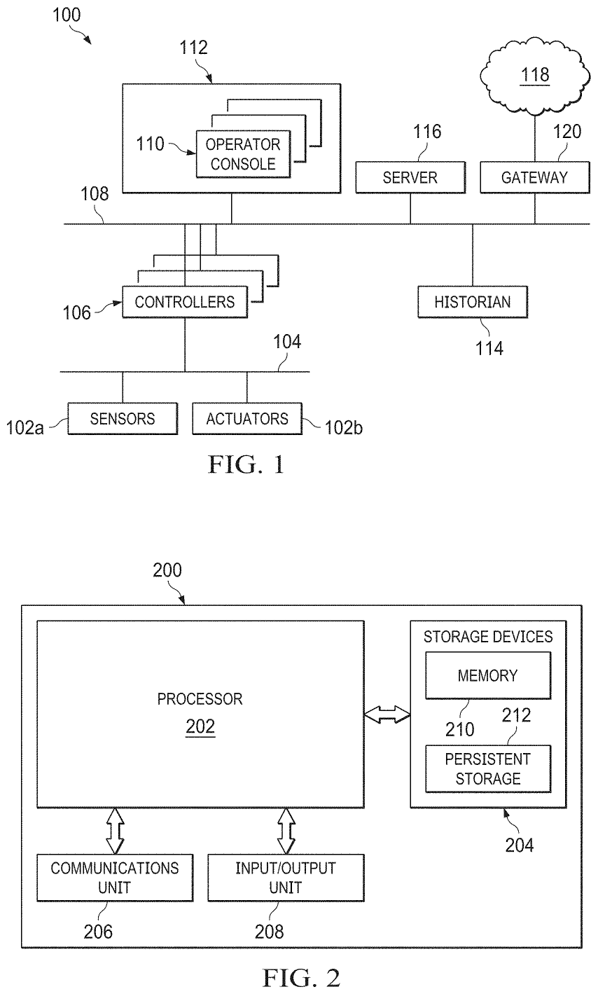

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any type of suitably arranged device or system.

Industrial process control and automation systems require maintenance and upkeep as well as rapid response to various alarms and warnings to maintain the industrial plant in an efficient, safe, and productive environment. In addition to the automation various personnel are required to make decisions and perform maintenance to ensure the industrial process control and automation systems run under normal operating conditions. The individual personnel can include process operators, system maintenance engineers, control engineers, field engineers, technicians, and the like.

Managing the large workforce of individuals and technicians is critical for the efficient operation of industrial process, control, and automation systems within an industrial plant. For example, individuals of varying skill and knowledge can lead to inconsistent operations during various shifts. Maintaining a high quality workforce of individuals and technicians requires each group of individuals to have a defined skill set, a way measure the skills and identify any gaps in a skill set, as well as provide personalized training to fill the identified gaps. By educating the operators and engineers on the areas only where an identified gap is present improves efficiency as the personnel are not required to undergo general training for various skills that that various personnel are not deficient in.

Due to the continual development of technology, the workforce and personnel who oversee an industrial plant are required to continually update their skill set in order to efficiently operate new equipment and the like. One method to assess the skills of individual is through assessment techniques like tests, to determine and identify on the job competency. Another method to assess the skills and competency of an individual is through analytics and monitoring responses to various warnings, alarms captured while each personnel is performing their daily tasks in the management and oversight of the industrial plant.

Embodiments of the present disclose include methods and systems to assess the various personnel such as process operators, system maintenance engineers, control engineers, field engineers, technicians and the like, based on identifying best practices, while remaining with the rules and standards of operating the industrial plant. While the various operators, system maintenance engineers, control engineers, field engineers, technicians and the like perform various tasks while maintaining and overseeing the industrial plant, analytical systems are used to record and analyze the various responses each individual performs in response to an alarm or warning as well as preventative maintenance procedures.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, flow rate, or a voltage transmitted through a cable. Also, the actuators 102b could alter a wide variety of characteristics in the process system, such as valve openings. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network (such as one supporting a FOUNDATION FIELDBUS protocol), electrical signal network (such as a HART network), pneumatic control signal network, or any other or additional type(s) of network(s).

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. For example, a controller 106 could receive measurement data from one or more sensors 102a and use the measurement data to generate control signals for one or more actuators 102b. A second set of controllers 106 could be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each controller 106 includes any suitable structure for controlling one or more aspects of an industrial process. At least some of the controllers 106 could, for example, represent proportional-integral-derivative (PID) controllers or multivariable controllers, such as controllers implementing model predictive control (MPC) or other advanced predictive control (APC). As a particular example, each controller 106 could represent a computing device running a real-time operating system, a WINDOWS operating system, or other operating system.

At least one network 108 couples to the controllers 106 and other devices in the system 100. The network 108 facilitates the transport of information between components. The network 108 could represent any suitable network or combination of networks. As particular examples, the network 108 could represent at least one Ethernet network.

Operator access to and interaction with the controllers 106 and other components of the system 100 can occur via various operator consoles 110. Each operator console 110 could be used to provide information to an operator and receive information from an operator. For example, each operator console 110 could provide information identifying a current state of an industrial process to the operator, such as values of various process variables and warnings, alarms, or other states associated with the industrial process. Each operator console 110 could also receive information affecting how the industrial process is controlled, such as by receiving set points or control modes for process variables controlled by the controllers 106 or other information that alters or affects how the controllers 106 control the industrial process. Each operator console 110 includes any suitable structure for displaying information to and interacting with an operator. For example, each operator console 110 could represent a computing device running a WINDOWS operating system or other operating system.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

The control and automation system 100 here also includes at least one historian 114 and one or more servers 116. The historian 114 represents a component that stores various information about the system 100. The historian 114 could, for instance, store information that is generated by the various controllers 106 during the control of one or more industrial processes. The historian 114 includes any suitable structure for storing and facilitating retrieval of information. Although shown as a single component here, the historian 114 could be located elsewhere in the system 100, or multiple historians could be distributed in different locations in the system 100.

Each server 116 denotes a computing device that executes applications for users of the operator consoles 110 or other applications. The applications could be used to support various functions for the operator consoles 110, the controllers 106, or other components of the system 100. The servers can be located locally or remotely from the control and automation system 100. For instance, the functionality of the server 116 could be implemented in a computing cloud or a remote server communicatively coupled to the control and automation system 100 via a gateway such as gateway 120. Each server 116 could represent a computing device running a WINDOWS operating system or other operating system. Note that while shown as being local within the control and automation system 100, the functionality of the server 116 could be remote from the control and automation system 100. For instance, the functionality of the server 116 could be implemented in a computing cloud 118 or a remote server communicatively coupled to the control and automation system 100 via a gateway 120.

In accordance with this disclosure, managing the competency and skill level of an industrial plants workforce is critical for an efficient plant operation. Process control and maintenance of an industrial plant can require a large workforce of personnel covering various aspects of the industrial plant. In certain embodiments, the personnel are categorized into various groups such as, process operators, system maintenance engineers, control engineers, field engineers, and the like. The various components of defining competency can include defining skills needed for each group, identifying gaps of individuals against the identified skills, and training the personnel to reduce knowledge gaps. For example, the competency of an operator can be measured established as how efficiently each operator responds to an alarm or warning. In another example, the competency of maintenance engineers can be measured as how efficiently each maintenance engineer configures a system or subsystem. In another example, the competency of a field engineer can be measured as how efficiently the field engineer is at maintaining the various devices and equipment at the industrial plant. For example, by collecting and analyzing data on the various tasks that each personnel performs during the operation of an industrial plant, embodiments of the present disclosure provides real-time information and guidelines on how the various personnel can respond to each event in an efficient and safe manner. By analyzing each personnel and identifying skill areas where individual personnel are less efficient than others provides an indication that by providing additional training in a specific area will affect the overall efficiency of the industrial plant.

Although FIG. 1 illustrates one example of an industrial process control and automation system 100, various changes may be made to FIG. 1. For example, the control and automation system 100 could include any number of sensors, actuators, controllers, servers, networks, operator stations, operator consoles, control rooms, historians, networks, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

Industrial processes can be implemented using large numbers of devices, such as pumps, valves, compressors, or other industrial equipment. Similarly, industrial process control and automation systems can be implemented using large numbers of devices, such as the sensors 102a, actuators 102b, controllers 106, and other components in FIG. 1. Various networks can be used to couple these devices together and transport information.

FIG. 2 illustrates an example device for competency assessment according to this disclosure. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information as well as generating a report of the analysis. For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device.

Although FIG. 2 illustrates example computing device 200 capable of identifying skills and competency gaps various changes may be made to FIG. 2. For example, various components in FIG. 2 could be combined, further subdivided, or omitted, and additional components could be added according to particular needs. As a particular example, processor 202 can be divided into multiple processors, such as one or more central processing units (CPUs) and one or more graphics processing units (GPUs). Also, computing device 200 can come in a wide variety of configurations, and FIG. 2 does not limit this disclosure to any particular computing device or mobile device.

As noted above, numerous individuals are required for the efficient and effective running of an industrial plant that utilizes various process control and automation systems. When one of the individuals responds slowly to a warning or alarm, performs the remediating action slowly, fails to perform preventative maintenance, or constructs a system poorly, the efficiency and productivity of the plant drop. Embodiments of the present disclosure provide analytical systems that analyze the various responses to identify the skill and knowledge gaps of the individuals while the various operators, maintenance engineers, system engineers, field engineers, and the like perform their respective tasks. For example, while the various operators, system maintenance engineers, control engineers, field engineers, technicians and the like perform their tasks on the various operator stations, analytical systems are used to record and analyze the various responses each individual performs in response to an alarm or warning as well as preventative maintenance procedures. The analysis of these data and the access of the real-time process data provide guidelines for operators in various responses to the process alarms in an efficient and safe manner.

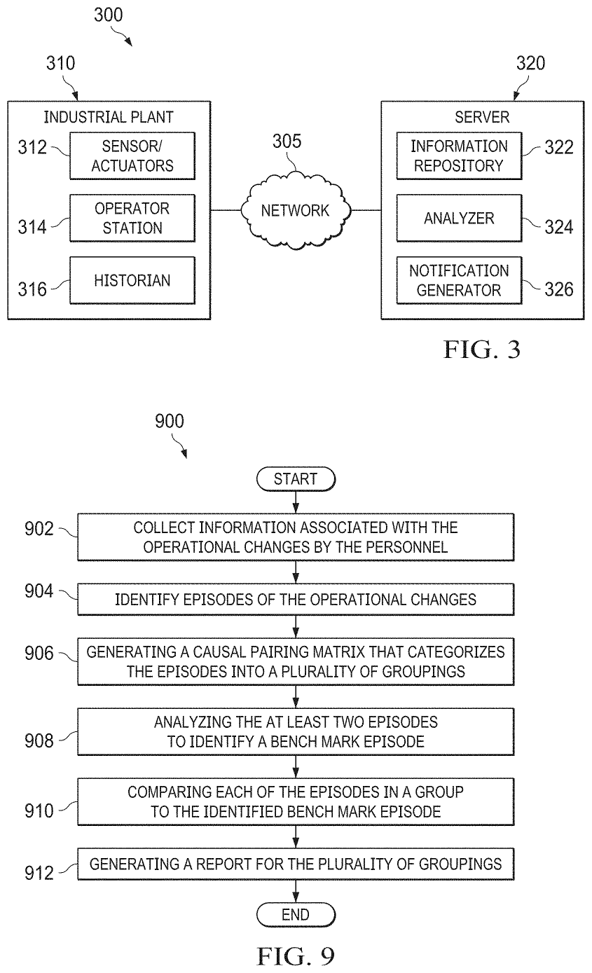

FIG. 3 illustrates an example block diagram of a communication system according to this disclosure. The embodiment of the high-level architecture 300 as shown in FIG. 3 is for illustration only. Other embodiments can be used without departing from the scope of the present disclosure. The high-level architecture 300 includes an industrial plant 310 and a server 320 in communication over network 305.

Network 305 is used to provide communication between the industrial plant 310 and the server 320. In certain embodiments, network 305 is similar to network 104 of FIG. 1. In certain embodiments, network 305 is similar to network 108 of FIG. 1. Network 305 can be personal area network (PAN), Local Area Networks (LANs), Wireless Local Area Networks (WLANs), the Public Switched Telephone Network (PSTN), as well as other wireless networks. Network 305 may also be the Internet, representing a worldwide collection of networks and gateways that use Transmission Control Protocol/Internet Protocol (TCP/IP) protocols to communicate with one another. Network 305 includes a cable, a router, switches a firewall, or a combination thereof (not depicted). Network 305 can include a variety of connections, such as, wired, wireless or fiber optic connections.

Industrial plant 310 is similar to industrial process control and automation system 100 of FIG. 1. The industrial plant 310 represents one or more industrial plants. The industrial plant 310 generally represents any system or portion thereof configured to process one or more products or other materials in some manner. The industrial plant 310 includes sensors and actuators 312, at least one operator station 314, and a historian 316.

The sensors and actuators 312 are similar to the sensors 102a and the actuators 102b of FIG. 1. In certain embodiments, sensors and actuators 312 also include equipment that is controlled by the automation system. The sensors and actuators 312 represent components in the industrial plant that perform any of a wide variety of functions. For example, sensors and actuators 312 measure various characteristics of the process system as well as alter any number of characteristics in the process system of the industrial plant 310. The sensors and actuators 312 can be automatically controlled by the process system of the industrial plant 310, manually controlled, or a combination thereof. The control and manipulation of the sensors by the personnel or the process system of the industrial plant 310, or the combination thereof can be recorded by the historian 316, discussed in further detail below. For example, each time the sensors and actuators 312 are adjusted, a record is created within the historian 316. When an analysis is performed, such as through analyzer 324, discussed in further details below the competency and skill level of the individual personnel who adjusted the sensors and actuators 312 can be assessed.

The operator station 314 is similar to the operator console 110 or the control rooms 112 of FIG. 1. Each operator station 314 represents computing or communication devices providing user access to the machine-level controllers, such as controllers 106 of FIG. 1. In certain embodiments, the operator consoles 110 receive and display warnings, alerts, or other messages or displays generated by various controllers of the industrial plant 310. The operator station 314 allows a user to enable or disable the various automatic controls to control the operation of the industrial plant 310. The operator stations 314 can also allow the user such as an operator to adjust the operation of the sensors and actuators 312 during the operation of the industrial plant 310. The operator station 314 allows users to review the operational history of sensors and actuators 312. In addition, each of the operator stations 314 can include any suitable structure for supporting user access and control of one or more components.

The historian 316 is similar to the historian 114 of FIG. 1. The historian 316 represents any suitable structure for storing and facilitating retrieval of information. The historian 316 can be implemented using any architecture known in the art such as, for example, a relational database, an object-oriented database, or one or more tables, or a combination thereof. The various information and data stored within the historian 316 can include confidential information, proprietary information, personnel information, operational history of the industrial plant 310, and the like. Although shown as a single centralized component within the industrial plant 310, the historian 316 could be located elsewhere in the high-level architecture 300, or multiple historians could be distributed in different locations in the high-level architecture 300. For example, the historian 316 can be a server or a remote server or a “cloud” of computers interconnected by one or more networks utilizing clustered computers and components to act as a single pool of seamless resources, accessible to industrial plant 310, the server 320, or both, via network 305.

The historian 316 could, for instance, store information associated with the operation of the industrial plant. For example, the historian 316 can maintain one or more logs that include the warnings, alarms, maintenance records, and process changes during the operation of the industrial plant 310. In certain embodiments, the following data can be collected by the historian 316: (i) Process alarms, (ii) Operator Process changes; (iii) System alarms; (iv) System status/events; (v) Engineering configuration changes; (vi) Piping and Instrumentation Diagrams and control narratives of process; (vii) Shift roasters and log-on information of stations; (viii) Maintenance records (Asset Management/Others); and the like. For example, process alarms include warnings and alarms that occur when one or more sensors detect a measurable characteristic that falls outside of an identified parameter. In another example a process alarm can occur when an actuator or another piece of equipment malfunctions. In another example, a process alarm can occur as a result of an operator action. For instance, an alarm can sound when an operator increases or decreases a setting beyond capabilities of the sensor, actuator, output parameter, and the like. Operator process changes occur when an operator or another personnel change one or more processes, parameters, of the automation system of the industrial plant 310. System status and events occur when any parameter changes during the operation of the industrial plant 310. Engineering configurations include various changes that an operator instructs the process to perform, such as changes to the operation of various components of the industrial plant 310.

Server 320 is similar to the server 116, the computing cloud 118, or a combination there of, of FIG. 1. Server 320 can be configured similar to the computing device 200 of FIG. 2. Server 320 can be a web server, a server computer such as a management server, or any other electronic computing system capable of sending and receiving data. In certain embodiments, the server 320 is a “cloud” of computers interconnected by one or more networks, where the server 320 is a computing system utilizing clustered computers and components to act as a single pool of seamless resources when accessed through network 305. In certain embodiments, the server 320 can also exist in cloud with appropriate connecting channel to a Distributed Control System (DCS). In certain embodiments, the server 320 can be used to provide assess an operator while responding to alarms. These measures improve the safe operation of the process as well its efficiency. In certain embodiments, the server 320 provides analytics to identify gaps in the in the competency of operators in responding to alarms in an efficient way. In certain embodiments, the server 320 provides analytics to identify gaps in the competency of maintenance engineers to correctly configure the system. In certain embodiments, the server 320 provides analytics to identify gaps in the competency of field engineers to correctly maintain the devices. In certain embodiments, the various analytical and identification methods and systems can be bundled as a single solution to generate periodic gap reports. In certain embodiments, the various analytical and identification methods and systems can be utilized for on the job competency assessments or re-assessments. Server 240 includes an information repository 322, an analyzer 324, and a notification generator 326.

The information repository 322 can be similar to storage device 204 of FIG. 2. In certain embodiments, the historian 316 and the information repository 322 are the same entity within the high-level architecture 300. The information repository 322 can be implemented using any architecture known in the art such as, for example, a relational database, an object-oriented database, or one or more tables, or a combination thereof. The information repository 322 stores data that is collected from the industrial plant 310, an external source, or both.

In certain embodiments, the various operations performed during the operation of the industrial plant 310 are continually recorded by the historian 316. For example, the information repository 322 collects the recorded events and records from the historian 316 for processing. In another example, the information repository 322 is a control database that collects or receives various engineering configurations associated with the operation of the industrial plant. In certain embodiments, the information repository 322 can collect all the information from the historian 316 and parse through the information. In certain embodiments, the information repository 322 can determine which records are applicable for deriving the skill level of personnel and select the specific records. For example, the information repository 322 can select records that concern with alarms, process changes, maintenance records, system changes, and the like.

The information repository 322 stores data that is used in the analysis to identify competency gaps within the personnel of the industrial plant 310. In certain embodiments, at least a portion of the information collected, and maintained by the historian 314 can be included in the information repository 322. For example, the information repository 322 can include all the information included in the historian. In another example, the information repository 322 can include one or more specific categories of data such as (i) Process alarms, (ii) Operator Process changes; (iii) System alarms; (iv) System status/events; (v) Engineering configuration changes; (vi) Piping and Instrumentation Diagrams and control narratives of process; (vii) Shift roasters and log-on information of stations; or (viii) Maintenance records (Asset Management/Others).

In certain embodiments, the following data can also be maintained in the information repository 322: (i) Engineering configurations; (ii) SOP/Operator Guidelines; (iii) System Performance Baseline (SPB) and Integrated Automation Assessment (IAA), if available; (iv) Custom graphics; and the like. In certain embodiments, the information repository 322 is a control database that maintains or receives various engineering configurations. In certain embodiments, the information repository 322 receives and stores the various engineering configurations from a control database. Engineering configurations can be collected from control database, whereas engineering configuration changes are collected by the historian 314. The SOP/operator guidelines can be collected from a user as an input or data entry. Operator guidelines include procedures and guidelines that the various personnel of the industrial plant 310 are instructed to follow. For instance, the operator guidelines can include how each personnel responds to a particular alarm. SPB performs an analysis of the utilization and throughput of the systems of the industrial plant 310, and can generate recommendations for improvement. SPB can also generate a report after the industrial plant 310 receives an upgrade. The SPB is a report that is provided by DCS vendors. The SPB report, for example can be prepared by experts in the field that indicate ideal and proper procedures and reposes as well as various industry standards associated with the industrial plant 310. The IAA is a generated report from another aspect of the industrial plant 310 issues with the equipment of the industrial plant 310.

The analyzer 324 analyzes the individual personnel at the industrial plant 310 to identify competency gaps. For example, the analyzer 324 analyzes the individual personnel based on how each individual responds to an alarm or warning, how the individual performs an install as well as how the individual configures various aspects of the industrial plant 310.

Analyzer 324 sorts all the information collected by the information repository 322, to identify competency gaps or deficient skills in certain personnel of the industrial plant 310. Analyzer 324 parses information within the information repository 322 such as, history, configuration, and the like. Analyzer 324 sorts the information into groups. In certain embodiments, each group indicates a particular skill associated with the running and operating the industrial plant 310. For example, one group can include all responses performed by personnel when a specific alarm occurs. In another example, another group can include all preventative maintenance performed on a type of equipment. In another example, one group can include particular changes executed by personnel to the processes of the industrial plant.

In certain embodiments, analyzer 324 receives a set of skills from a third party server. The received set of skills indicates various groups that the analyzer 324 is to sort the relevant information into. In certain embodiments, the analyzer 324 derives skills from the information maintained in the historian 314, the information repository 322, or both, and then sorts the relevant information into the respective group. For example, the analyzer 324 derivers patterns from the information. The patterns can indicate various responses the personnel performed when responding to particular alarms. The patterns can indicate various changes the personnel executed when adjusting parameters of the automated process of the industrial plant 310. The patterns can indicate various warnings and errors that occurred while a particular personnel oversaw the various equipment. After deriving a new skill, the analyzer 324 generates a new group that relevant information can be sorted within.

In certain embodiments, the analyzer 324 can identify episodes. An episode includes the start of an alarm or warning through the return of normal operating conditions as well as all the changes the operator executed within the system to return the system to normal operating conditions. Stated differently an episode spans the time between an alarm event and the corresponding return to normal event. The analyzer 324 can identify the number of changes the operator executed to return the system to normal operating conditions. Additionally, the analyzer 324 can identify the duration of time it took the operator to return the system to normal operating conditions.

In certain embodiments, the analyzer 324 can derive the time between an alarm event and the corresponding first action by an operator. For example, the analyzer can assess the time duration it takes a single operator to start responding to an alarm. In certain embodiments, the analyzer 324 can identify when the operator is addressing prior issue and therefore disregard any time delay in addressing the alarm that occurs while the operator is addressing the first alarm.

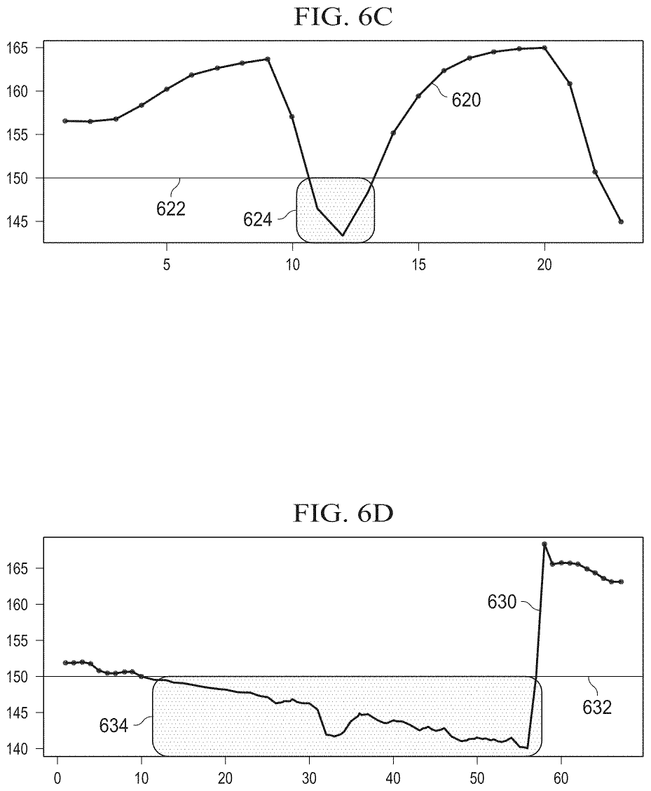

In certain embodiments, the analyzer 324 can assess the information within each group to identify a bench mark. A bench mark is the best response to or action taken as a result of a given skill or task. In certain embodiments, a bench mark episode is the integral of the difference between the actual and alarm trip point during the span of the alarm, identified as an index value. The index value is the value associated with each instance the processing values associated with the operation of the industrial plant 310 exceeds an alarm trip point. The alarm trip point is a value or parameter that a processing value associated with the operation of the industrial plant 310 is not to exceed. For example, the integral of the difference between the actual and alarm trip point is the highlighted area of that indicates alarm 604 of FIG. 6A, alarm 614 of FIG. 6B, alarm 624 of FIG. 6C and the alarm 634 of FIG. 6D. The bench mark is identified as the smallest highlighted area of similar alarms. In certain embodiments, a bench mark is the quickest response, the fewest number of changes of a combination thereof, while violating no plant rules or engineering guidelines to resolve a warning or an alarm. For example, the bench mark response to an alarm is the duration of time taken or the number of changes the operator executed to return the system to normal operating conditions, as compared to the other responses to a similar alarm type. In another example, the bench mark response to a system process is how many errors were generated while the new process is executed, how many guidelines the process violated, or the like, as compared to other similar processes. The analyzer 324 can then compare the data within each group to the bench mark. In certain embodiments the bench mark is identified in a report, and each episode is compared to the identified bench mark. For example, the report can be received from an external source or generated and provides instructions on responding to various types of alarms.

The analyzer 324 then ranks the information within each group. For example, the analyzer 324 assesses responses or the actions performed by each personnel, with respect to each identified skill, in order to rank (or rate) the personnel within each group. For example, analyzer 324 performs analytics to uncover hidden competency gaps within the personnel at the industrial plant 310.

The analyzer 324 can rank or rate operators in their response to alarms and running the various processes of the industrial plant 310 optimally. For example, the analyzer 324 analyzes a selection of alarms within a particular alarm grouping and identifies a correct quantitative response. The correct quantitative responses can include increments or rate of manipulations executed by each operator in order to resolve the alarm, and return the process to a non-alarm state. The analyzer 324 can also assess the response to of each operator for particular alarms. For example, the response time can include the total time it takes an operator to resolve the issue. In another example the response time can include the time it took the operator to commence addressing the alarm. The analyzer 324 can also assess the operators responses based on avoiding inadvertent operations while responding to a particular alarm. For example, the analyzer 324 can identify operations that an operator executed that are unnecessary, redundant, or wrong incorrect when responding to an alarm state.

In certain embodiments, the analyzer 324 can rank or rate personnel by assess an alarm episode characteristic and the operators response to the alarm. For example, the analyzer 324 can derive the time between an alarm and the first action of an operator as well as the time between the start of the alarm event and the return to normal event. The analyzer 324 can also derive the maximum deviation of the trip point. The trip point is the value configured for the alarm event to trigger. For example, the trip point indicates a value as to when an alarm occurs based on one or more system parameters. The analyzer 324 can also derive the time between an alarm event and the maximum deviation from the trip point. The analyzer 324 can then map a portion or all the information to compare each operator.

The analyzer 324 can also rank or rate control system maintenance engineers based on minimizing defects in the control configurations and process optimization skills. For example, the analyzer 324 can assess when a particular configuration violates a Front End Engineering Design (FEED) rule. FEED rules includes various rules and conventions to be followed during the operation of the industrial plant 310. In another example, the analyzer 324 can assess when a particular configuration contains logical errors. The analyzer 324 can also rank or rate control system maintenance engineers based on implementation of custom graphics such as optimization of parameter access. The analyzer 324 can also rank or rate control system maintenance engineers based on alarm configurations, advanced application data access optimization, controller input and outputs, SPB reporting, or a combination thereof.

In certain embodiments, the analyzer 324 can compare each personnel to the derived bench mark. For example, bench marks can be established based on how an operator responds to an alarm as well as an engineer is able to establish a control configuration with minimal defects. Thereafter the analyzer 324 compares the information within each group to the derived bench mark. The closer each personnel is to the bench mark the higher the rank, and conversely the further away each personnel is from the bench mark the lower the rank.

In certain embodiments, the rank of each personnel is a rating that indicates how well each individual performs with respect to the bench mark or the peers of the individual. For example, if all the personnel within a particular episode group respond similarly, the rating of the personnel will be similar.

The notification generator 326 generates reports that include a listing of personnel whose skill falls is below a threshold. The notification generator 326 can also generate reports that indicate personnel who are associated with a bench mark or have actions that are approaching a bench mark. The notification generator 326 can be performed routinely, periodically or on demand. For example, a report can be generated once every month, quarter, year, or the like. The report indicates competency gaps or skills that particular personnel could use additional education to overcome the deficiency. The report can also include a listing of the best practices of process operations. The reports can also include exceptions that were not considered while assessing a potential competency gap for each personnel.

In certain embodiments, the notification generator 326 outputs the skill deficiencies to a training module that can generate a personalized training simulation for each personnel whose skill was below the threshold. For example, the training simulation for each personnel can be based on the bench mark.

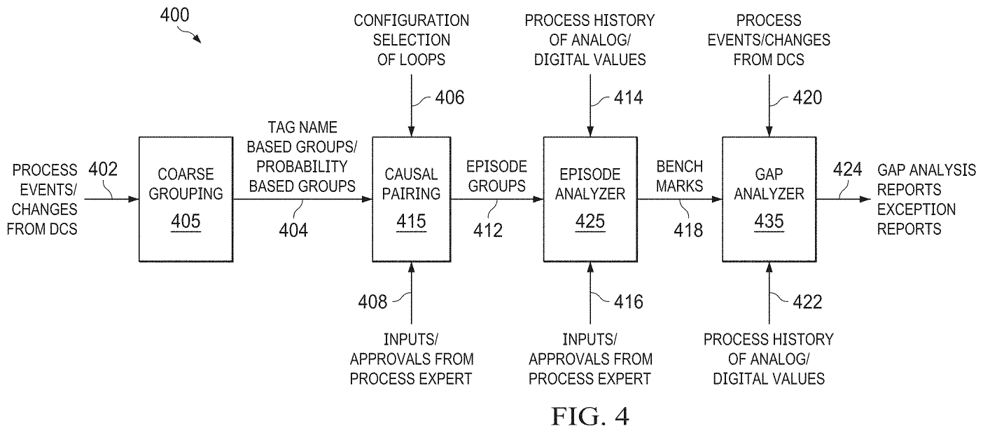

FIG. 4 illustrates an example competency assessment diagram 400 according to this disclosure. The embodiment of the diagram 400 as shown in FIG. 3 is for illustration only. Other embodiments can be used without departing from the scope of the present disclosure.

Diagram 400 illustrates that coarse grouping 405 receives information 402. Information 402 includes process events or changes from a DCS. For example, the information 402 can include process alarms that are recorded at the sight. In certain embodiments, the coarse grouping 405 filters, cleans, and formats information 402. In certain embodiments, the coarse grouping 405 performs a coarse computational grouping of the information 402. In certain embodiments, the coarse grouping 405 performs an initial analysis of the data by grouping similar events that occurred during the process system of the industrial plant 310 as well as various actions an operator performed in response to events. For example, the coarse grouping 405 can tag the information 402 based on identifying the particular groups the information 402 is sorted into. For instance, the tag can be a general alarm tag or a tag that belongs to a particular alarm. A tag can be applied to the information 402 based on a particular value or measurement that is identified from the information 402. In another example, the coarse grouping 405 can tag subsets of the information 402 based on a probability that each subset of the information 402 belongs in a particular group. The probability tag can be associated with information 402 based on a particular scenario. For instance, if a particular alarm occurs, what is the probability that an operator will take a particular action, or sequence of actions. That is, the tag can be applied to the information when the coarse grouping 405 identifies that a certain percentage that if a particular alarm occurs the operator will perform certain action(s). The coarse grouping 405 outputs the tagged named based groups, the probability based groups, or a combination thereof as coarse grouped information 404.

The causal pairing 415 receives the coarse grouped information 404. The causal pairing 415 links alarms to operator actions or engineering configurations based on the tags. In certain embodiments, the causal pairing 415 receives configuration selection of loops 406 as well as inputs or approvals from process experts 408. Loops 406 include various process loops used in the automation of the industrial plant 310. For example, an operator might be expected to keep various measurable variables within certain tolerance levels or avoid a processing system reaching an alarm trip point. When the variable exceeds an upper or lower tolerance level and enters within the alarm trip point, an alarm can occur. The loop 406 can include additional information that indication as to how well the measurable variable is maintained within the parameters, even when an alarm does not occur. Inputs and approvals from an expert 408 include setting, configurations, and parameters that are established as rules within the industrial plant 310, and a violation of one of the said rules can occur even when no alarm is sounded.

Causal pairing 415 analyzes the received information and identifies individual episode groups 412. Each episode is the start of an alarm of a triggering event, includes all of the actions performed by a particular personnel, and concludes when the process returns to a normal state. Each episode group is a grouping of similar episodes.

Episode analyzer 425 receives the episode groups 412. In certain embodiments, the episode analyzer 425 also receives process history of analog or digital values 414 as well as the input or approvals from process experts 416. The history of analog or digital values 414 includes various parameters or values associated with the industrial plant 310 with respect to the particular episode from the episode group 412. For example, the episode analyzer 425 analyzes each episode and assesses the various process values 414 that are associated with the industrial plant 310. The input or approvals from process experts 416 are similar to the input or approvals from process experts 408. For example, the episode analyzer 425 analyzes each episode and ascertains whether an episode violated one of the rules established by the process expert via the input or approvals from process experts 416. The Episode analyzer 425 generates a bench mark 418 for each episode group.

The bench mark 418 indicates particular episodes within each episode group that were responded to best. For example, the episode that is identified as a bench mark can have reduced integral value, where the integral value is the difference between process value and alarm trip point. In another example, the response could have been handled the quickest, less steps were performed, configuration violated the least expert rules, and the like. The bench mark 418 is identified as the ideal solution. In certain embodiments, the bench mark 418 is identified by the received approvals from process experts 416, such that the episode analyzer 425 simply identifies at least one episode that matches or closely matches the parameters of the approvals from process experts 416.

The gap analyzer 435 receives the bench mark 418 for each episode group. In certain embodiments, the gap analyzer 435 also receives process events and changes from DCS 420. The process events and changes from DCS 420 are similar to the information 402. In certain embodiments, the gap analyzer 435 also receives history of analog or digital values 422. The history of analog or digital values 422 is similar to the history of analog or digital values 414. The gap analyzer 435 analyzes the bench marks of each episode group to the various process events and changes to the DCS 420 as well as the history of analog or digital values 422 to identify areas where induvial personnel responded or performed poorly. The gap analyzer 435 generates a gap analysis report as well as an exception report. The gap analysis report indicates induvial personnel responded or performed poorly. The exception report depicts episodes where particular personnel exhibit a competency gap, but extenuating circumstances where identified that indicate the personnel do not have a competency gap. For example, while the operator is responding to a first alarm, a second occurs. If the operator does not respond to the second alarm, as the operator is addressing the first alarm, a knowledge or skill gap could be indicated with respect to the second alarm. Therefore, the exception report depicts the extenuating circumstance. In another example, various alarms can include a tag that indicates varying levels of priority, such as a high, medium, and low priority tag. If an operator is engaged in a higher priority alarm, alarms with a lower priority tag may incur a delay in the response by an operator. A knowledge or skill gap could be generated to indicate a reason for the delay with respect to the lower priority level alarms, while the operator is responding to the higher priority alarm. Therefore, the exception report depicts the extenuating circumstance.

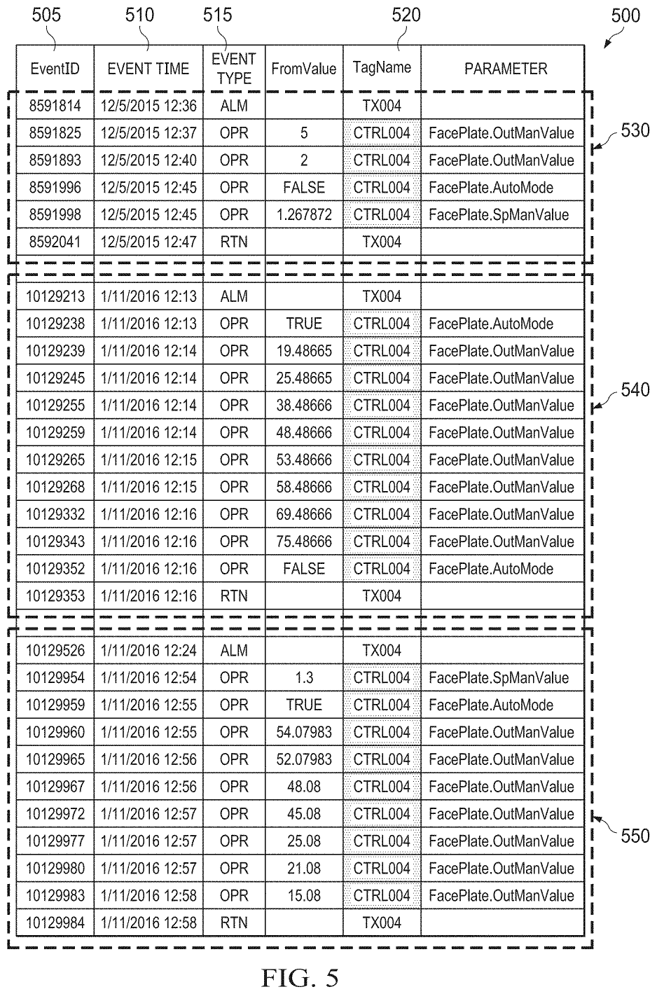

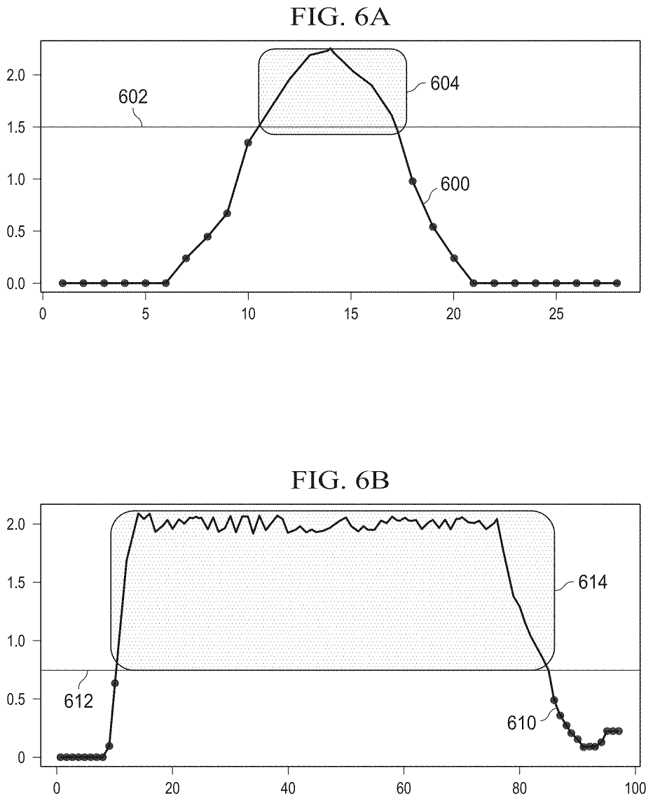

FIG. 5 illustrates an example response log according to this disclosure. In particular FIG. 5 illustrates response log 500 depicting an operators response to three alarm episodes, that of episode 530, 540 and 550. The response log 500 includes an event ID 505, an event time 510, an event type 515, and a tag name 520.

The episodes 530, 540, and 550 illustrated start and end at the time and date indicated in the event time 510 column. Each episode 530, 540, and 550 has a different span of time and has been managed with different quantitative and qualitative responses by various operators. Each event, including the alarm, the return to normal state and each action the operator performs to resolve the alarm are given an event ID 505. The event type 515 indicates whether an alarm occurs (ALM), an operator performs a particular action (OPR) or whether the system retunes to a normal state (RTN). The tag name 520 indicates that each the episode 530, 540 and 550 correspond to the same or similar alarm type.

An analysis of these episodes can statistically and analytically identify the best managed episodes against the poorly managed ones. For example, episode 530 depicts that the operator performed four actions over between 12:36 and 12:47, an eleven minute span. Episode 540 depicts that the operator performed ten actions over between 12:13 and 12:16, a three minute span. Episode 550 depicts that the operator performed nine actions over between 12:24 and 12:58, a thirty-four minute span. It is appreciated that episode 550 is the worst as it took a significantly longer time to resolve the alarm than episode 530 or 540. In episode 540 the operator performed more actions than the operator in episode 530 even though the operator resolved the issue in a shorter time period.

In certain embodiments, the best-managed episodes, such as episode 530 or 540, are bench marked as the exemplary ones to be compared against the future episodes, such as episode 550. Such comparisons enable the analyzer 324 of FIG. 3 to aggregate the bad episodes and visualize a pattern of operation. The analyzer 324 of FIG. 3 can then identify a pattern that can lead to the inference of such as a skill or knowledge gap of the operator controlling the process during a bad episode.

FIGS. 6A-D illustrate example graphical response logs according to this disclosure. FIGS. 6A-D illustrate example graphical representations of an operator's response to various episodes. FIGS. 6A and 6C illustrate a bench mark response while FIGS. 6B and 6D illustrate a response indicating a competency gap.

FIG. 6A illustrates a measureable variable 600 of the industrial plant that spikes above a threshold or an alarm trip point 602. That is, when the measureable variable 600 is elevated above the alarm trip point 602, an alarm 604 occurs. The alarm 604 represents the integral as derived by the area depicting the difference between the between actual process value and alarm trip point. The measurable variable 600 can be pressure, temperature, volume level, flow rate, and the like. FIG. 6B illustrates a similar episode to that of FIG. 6A. In particular FIG. 6B illustrates the measureable variable 610 spiking above the alarm trip point 612. The alarm 614 occurs as a result. Comparing the alarm 604 to 614 illustrates that the operator of FIG. 6A responding quicker than the operator of FIG. 6B. It can be inferred from the operator of FIG. 6B, has a competency or skill gap with respect to that particular alarm.

FIG. 6C illustrates a measureable variable 620 of the industrial plant that drops below an alarm trip point 622, whereby alarm 624 occurs. The measurable variable 620 can be pressure, temperature, volume level, flow rate, and the like. FIG. 6D illustrates a similar episode to that of FIG. 6C. In particular FIG. 6D illustrates the measureable variable 630 slowly falling below the alarm trip point 632. The alarm 634 occurs as a result of the variable falling below the alarm trip point 632. Comparing the alarm 624 to 634 illustrates that the operator of FIG. 6C responding quicker than the operator of FIG. 6D. It can be inferred that the operator of FIG. 6D was inattentive or failed to appreciate the eventual alarm state as the measurable variable 630 gradually approached the alarm trip point 632. It can additionally be inferred from the operator of FIG. 6D, has a competency or skill gap with respect to that particular alarm.

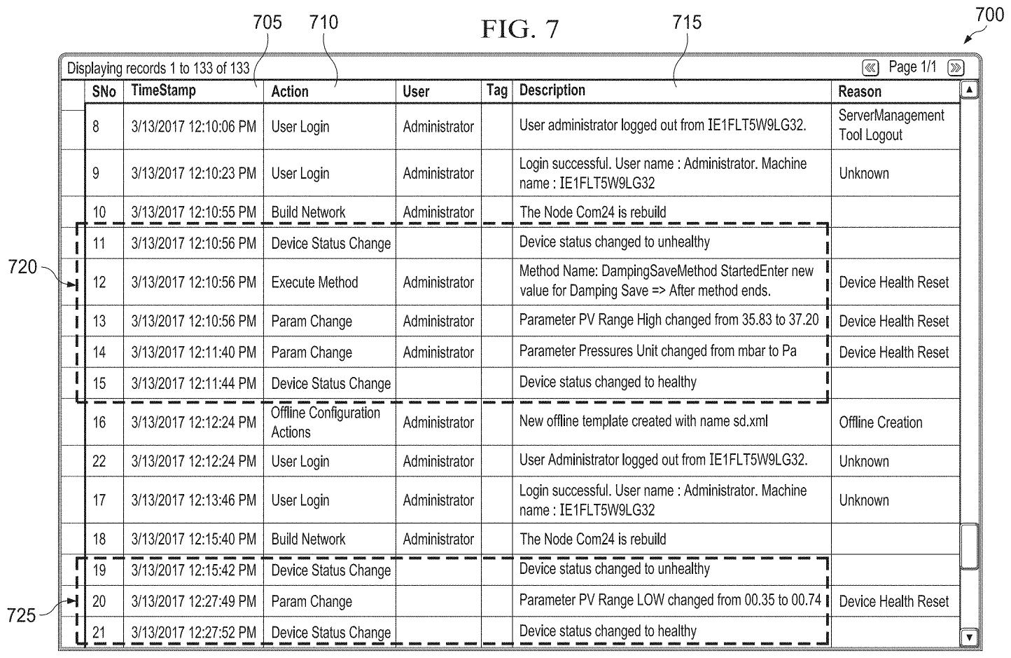

FIG. 7 illustrates an example field report according to this disclosure. In particular FIG. 7 illustrates field report 700 depicting a field engineers response log to two episodes, that of episode 720 and episode 725. The field report includes a time stamp 705, an action performed 710, and a description of the action 715.

The episodes 720 and 725 illustrate two episodes where a device status changed from health to unhealthy as indicated in the description 715. Each episode has a different span of time and has been managed with different quantitative and qualitative responses by various operators. Each episode 720 and 725 has an event that indicates the “device status chanted to unhealthy,” various parameter changes executed by the field engineer, and is resolved when the automation system indicates that the “device status changed to healthy.” Based on the various records and logs, the analyzer 324 of FIG. 3 can identify situations as a bench mark and compare all other similar situations to the bench mark scenario. The analyzer 324 can also cross reference the situation to other ongoing situations to identify if the engineer or operator was preoccupied with a separate issue.

An analysis of these episodes can statistically and analytically identify the best managed episodes against the poorly managed ones. For example, episode 720 depicts that the operator performed three actions, such as executing a method and changing various parameters, over period of less than one minute. Episode 725 depicts that the operator performed a single action over period of 12 minutes. It is appreciated that episode 725 took significantly longer to perform even though only a single action was performed. In certain embodiments, the analyzer 324 of FIG. 3 can determine whether either operator violated an engineering rule or a plant rule when performing one or more actions. If it is determined that operator violated a rule, the episode could be tagged as requiring additional training.

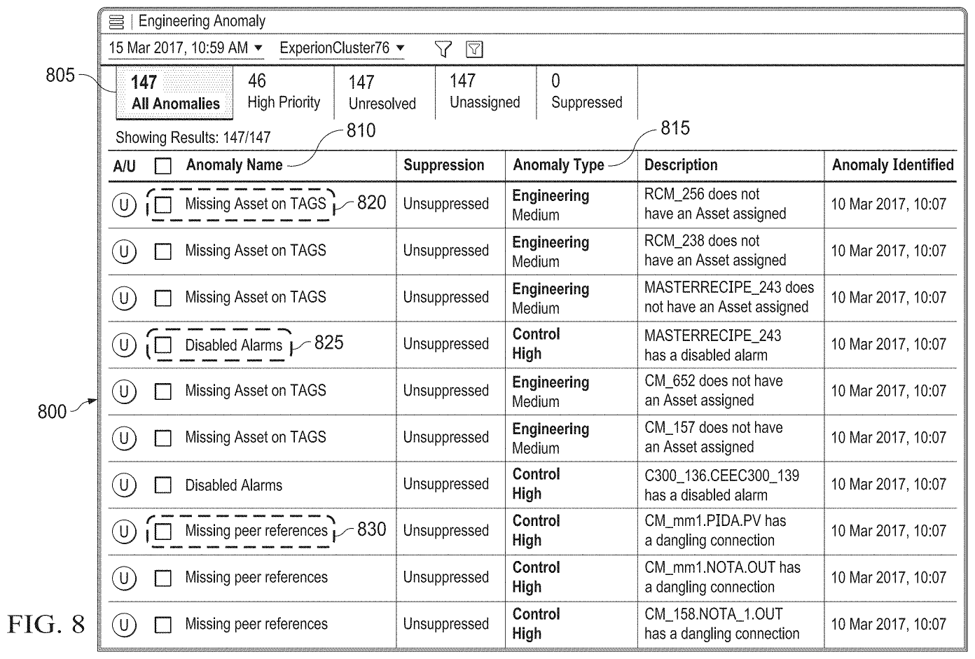

FIG. 8 illustrates an example maintenance log according to this disclosure. In particular FIG. 8 illustrates a report 800 listing detected defects in an engineering configuration. The report 800 can be generated by analyzing various configurations of the automation system of the industrial plant 310 and identify whether a FEED rule violation occurred. The report 800 identifies various detected defects. In particular, the tab 805 indicates that there are a total of 147 defects. The report 800 includes an anomaly name 810 and an anomaly type 815. The anomaly name 810 indicates the name of each detected anomaly. The anomaly type 815 indicates the type of the anomaly such as whether the anomaly is an engineering issue or a control issue as well as a ranking of the anomaly, such as medium or high.

For example, anomaly 820 indicates that a particular area of the industrial plant 310 designated as RCM_256 does not have an asset assigned to it. The defect rating for anomaly 820 is medium. In another example, anomaly 825 indicates that a particular alarm is disabled. The defect rating for anomaly 825 is high. In another example, anomaly 830 indicates that a various control system has a missing peer references, that of a dangling connection. The defect rating for anomaly 830 is high. The analyzer 324 of FIG. 3 can analyze each anomaly 820, 825, and 830 and determine whether the maintenance engineer has a competency gap with respect to the anomaly. In certain embodiments, the anomalies can be analyzed under orthogonal defect classification leading to the inference of competency gaps in the engineers.

FIG. 9 illustrates a method 900 for identifying skill level of personnel according to this disclosure. FIG. 9 does not limit the scope of this disclosure to any particular embodiments. While method 900 depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. For ease of explanation, the method identifying skill level of personnel is described with respect to the computing device 200 of FIG. 2, the server 320 of FIG. 3. However, the method 900 can be used with any other suitable system.

At step 902, the server 320 collects information associated with the operation of an industrial plant. The information is associated with operational changes performed by the personnel who operate the industrial plant. In certain embodiments, the information includes operational data, system configuration data and maintenance logs. In certain embodiments, the server 320 selects particular information from the historian 114 associated with the process control and automation system 100 of FIG. 1. In certain embodiments, the server 320 receives all the information directly from the historian 114. In certain embodiments, the historian 114 is associated with both the process control and automation system 100 and the server 320.

At step 904, the server 320 identifies episodes of the operational changes. Each episode includes a triggering event and operational changes performed by each of the personnel in response to the triggering event. Each episode includes a start of an incident, each action performed by each personnel in response to the incident in order to resolve the incident, and a conclusion of the incident. The incident is an alarm or a warning that occurs during the operation of the industrial plant and is resolved based on one or more inputs by the one or more personnel.

In certain embodiments, the triggering event is an alarm that occurs during the operation of the industrial plant. In certain embodiments, the triggering event is a warning that occurs during the operation of the industrial plant. In certain embodiments, the triggering event is a maintenance event that occurs during the operation of the industrial plant. In certain embodiments, the triggering event is a device failure that occurs during the operation of the industrial plant. In certain embodiments, the triggering event is a programming event that occurs during the operation of the industrial plant. In certain embodiments, the triggering event is associated with operational rules of the industrial plant that were violated during the operation of the industrial plant.

In step 906, the server 320 generating a causal pairing matrix. The causal pairing matrix detects patterns from the collected information. The causal pairing matrix detects patterns from the triggering event associated with the identified episodes. The causal pairing matrix detects patterns from the operational changes associated with the identified episodes. The causal pairing matrix detects patterns from a set of operational history associated industrial plant. The causal pairing matrix detects patterns from operational rules of the industrial plant associated with the identified episodes. The causal pairing matrix then derives a probability rating. The causal pairing matrix can also indicate non-coincident occurrences make the causal pairs distinct. The probability rating is based on the detected patterns. In certain embodiments, the probability rating indicates whether the personnel will perform one or more operational changes in response to a particular triggering event.

In certain embodiments, the causal pairing matrix detects patterns from the information. The patterns can indicate various responses the personnel performed when responding to particular alarms. The patterns can indicate various changes the personnel executed when adjusting parameters of the automated process of the industrial plant. The patterns can indicate various warnings and errors that occurred while a particular personnel oversaw the various equipment or automation systems.

The causal pairing matrix categorizes the identified episodes into a plurality of groupings. Each of the groups includes at least two episodes that are related. In certain embodiments, the episodes are related based on a similar triggering event for each of the episodes in a group. For example, the causal pairing matrix sorts the collected information into a plurality of groups. Each group corresponds to a similar triggering event occurred during the operation of the industrial plant.

At step 908 the server 320 analyzes the episodes in a group to identify a bench mark episode. In certain embodiments, when identifying the bench mark episode within each of the group, the server 320 evaluates a number of the operational changes performed by the personnel of each of the at least two episodes, to resolve the similar triggering event. In certain embodiments, when identifying the bench mark episode within each of the group, the server 320 evaluates the operational changes performed by the personnel of each of the at least two episodes, in response to the triggering event. In certain embodiments, when identifying the bench mark episode within each of the group, the server 320 evaluates the operational changes not performed by the personnel of each of the at least two episodes, in response to the triggering event. In certain embodiments, when identifying the bench mark episode within each of the group, the server 320 evaluates a quantity of the operational changes associated with each of the at least two episodes that did not conform to plant operational rules. In certain embodiments, when identifying the bench mark episode within each of the group, the server 320 evaluates a duration of time utilized by each of the at least two episodes in order to resolve the similar triggering even. In certain embodiments, when identifying the bench mark episode within each of the group, the server 320 evaluates a set of operational history related to each of the at least two episodes. For example, a bench mark episode is an index value that illustrates the integral of the difference between the actual and the alarm trip point, where the integral as derived by the area between the alarm trip point and the actual value that exceeds the tolerances as indicated by the alarm trip point. In another example, a bench mark episode within each group can be established based on how an operator responds to an alarm, as well as how an engineer is able to establish a control configuration with minimal defects. In another example, a bench mark episode is defined by an expert report and therefore may not include a triggering event. For instance, the bench mark episode can describe a preferred or ideal operational change by an operator.

At step 910, the server 320 compares the information within each group to rank the episodes. In certain embodiments, the server 320 ranks the one or more personnel with respect to the skill that is performed during the operation of the industrial plant. For example, the server analyzes the sorted data and ranks the responses and actions performed by each personnel with respect to each group. In certain embodiments, the server 320 rates the personnel within each episode group.

In certain embodiments, when the server 320 compares each of the at least two episodes to the identified bench mark episode within each of the groups, the server evaluates a number of the operational changes performed by the personnel of each of the at least two episodes, to resolve the similar triggering event.

In certain embodiments, when the server 320 compares each of the at least two episodes to the identified bench mark episode within each of the groups, the server evaluates the operational changes performed by the personnel of each of the at least two episodes, in response to the triggering event. In certain embodiments, when the server 320 compares each of the at least two episodes to the identified bench mark episode within each of the groups, the server evaluates the operational changes not performed by the personnel of each of the at least two episodes, in response to the triggering event. In certain embodiments, when the server 320 compares each of the at least two episodes to the identified bench mark episode within each of the groups, the server evaluates a quantity of the operational changes associated with each of the at least two episodes that did not conform to plant operational rules. In certain embodiments, when the server 320 compares each of the at least two episodes to the identified bench mark episode within each of the groups, the server evaluates a duration of time utilized by each of the at least two episodes in order to resolve the similar triggering event. In certain embodiments, when the server 320 compares each of the at least two episodes to the identified bench mark episode within each of the groups, the server evaluates a set of operational history related to each of the at least two episodes.

In certain embodiments, the server 320 ranks the personnel based on the operators response to the alarm, the time it takes an operator to first respond to an alarm, the duration of time it took the operator to resolve the alarm, the number of steps the operator performed while resolving the alarm, the number of rule violations that occurred, the severity of the rule violations that occurred (if any), the severity of the alarm based on deviation from the trip point, and the like. The closer each personnel is to the bench mark the higher the rank, and conversely the further away each personnel is from the bench mark the lower the rank.

At step 912, the server 320 generates a report. The generated report indicates the rating of each episode within a particular group. In certain embodiments, the report can indicate each episode that is ranked below a threshold. The threshold is preset level that indicates that the induvial will benefit from training. In certain embodiments, the threshold is a bell curve. For example, all the personnel within a group exhibit a similar rating, except for a select few, then the threshold is adjusted to indicate that those individuals are below the curve. In certain embodiments, the report can be generated routinely, periodically or on demand. The report indicates competency gaps or skills that are deficient where particular personnel could utilize additional education to overcome the deficiency. The report can also include a listing of the best practices of process operations.

In certain embodiments, the server 320 generates a training module that is a personalized training simulation for each personnel whose skill was below the threshold. For example, the training simulation for can be based on the bench mark.

In certain embodiments, the server 320 identifies personnel type associated with each episode. In certain embodiments, the identified personally type is based in part on the triggering event and the operational changes performed. In certain embodiments, personnel type is an operator, a maintenance engineer, or a field engineer. For example, the server 320 can identify an operator based on how the operator responds to an alarm at the industrial plant. In another example, the server 320 identifies a maintenance engineer based on how the maintenance engineer configures a system the industrial plant. In another example, the server 320 identifies a field engineer based on how the field engineer maintains a plurality of devices at the industrial plant.

It may be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
collecting information associated with operational changes by personnel that operate an industrial plant;
identifying episodes of the operational changes, wherein each episode includes a triggering event and the operational changes performed by each of the personnel in response to the triggering event;
generating a causal pairing matrix that categorizes the identified episodes into a plurality of groupings, wherein each of the groups includes at least two episodes that are related based on the triggering event of each of the at least two episodes being similar;
analyzing the at least two episodes to identify one of the at least two episodes as a bench mark episode, within each of the groups;
comparing each of the at least two episodes to the identified bench mark episode to rank the operational changes performed by each of the personnel of the at least two episodes, within each of the groups; and
generating a report for the plurality of groupings, wherein the report indicates the rank of the at least two episodes in each of the groups.

2. The method of claim 1, wherein identifying the bench mark episode within each of the groups and comparing each of the at least two episodes to the identified bench mark episode within each of the groups, comprises, evaluating:
a number of the operational changes performed by the personnel of each of the at least two episodes, to resolve the similar triggering event;
the operational changes performed by the personnel of each of the at least two episodes, in response to the triggering event;
the operational changes not performed by the personnel of each of the at least two episodes, in response to the triggering event;
a quantity of the operational changes associated with each of the at least two episodes that did not conform to plant operational rules;
an index value that indicates a difference between an alarm trip point and an actual value of the triggering event;
a duration of time utilized by each of the at least two episodes in order to resolve the similar triggering event; and
a set of operational history related to each of the at least two episodes.

3. The method of claim 1, wherein generating the causal pairing matrix, comprises:
detecting patterns from the collected information including:
the triggering event associated with the identified episodes,
the operational changes associated with the identified episodes,
a set of operational history associated industrial plant, and
operational rules of the industrial plant associated with the identified episodes; and
deriving a probability rating based on the detected patterns, wherein the probability rating indicates whether the personnel will perform one or more operational changes in response to a particular triggering event.

4. The method of claim 1, further comprising identifying a personnel type associated with each of the identified episodes based in part on the triggering event and the operational changes performed, wherein the personnel type is an operator, a maintenance engineer, or a field engineer.

5. The method of claim 1, wherein the triggering event includes at least one of
an alarm that occurs at the industrial plant;
a warning that occurs at the industrial plant;
a maintenance event that occurs at the industrial plant;
a device failure that occurs at the industrial plant;
a programming event that occurs at the industrial plant; and
a violation of an operational rule of the industrial plant.

6. The method of claim 1, wherein the collected information includes operational data, system configuration data, and maintenance logs.

7. The method of claim 1, further comprising indicating in the generated report each episode of the at least two episodes that is ranked below a threshold in each of the groups.

8. The method of claim 7, further comprising generating a training module, based on the identified bench mark episode, for each of the groups that include at least one episode that is ranked below the threshold, wherein the training module provides a personalized simulation to each personnel associated with the at least one episode ranked below the threshold.

9. An electronic device comprising:
a receiver configured to collect information associated with operational changes by personnel that operate an industrial plant;
a processor operably coupled to the receiver, wherein the processor is configured to:
identify episodes of the operational changes, wherein each episode includes a triggering event and the operational changes performed by each of the personnel in response to the triggering event;
generate a causal pairing matrix that categorizes the identified episodes into a plurality of groupings, wherein each of the groups includes at least two episodes that are related based on the triggering event of each of the at least two episodes being similar;
analyze the at least two episodes to identify one of the at least two episodes as a bench mark episode, within each of the groups;
compare each of the at least two episodes to the identified bench mark episode to rank the operational changes performed by each of the personnel of the at least two episodes, within each of the groups; and
generate a report for the plurality of groupings, wherein the report indicates the rank of the at least two episodes in each of the groups.

10. The electronic device of claim 9, wherein to identify the bench mark episode within each of the groups and to compare each of the at least two episodes to the identified bench mark episode within each of the groups, the processor is further configured to, evaluate:
a number of the operational changes performed by the personnel of each of the at least two episodes, to resolve the similar triggering event;
the operational changes performed by the personnel of each of the at least two episodes, in response to the triggering event;
the operational changes not performed by the personnel of each of the at least two episodes, in response to the triggering event;
a quantity of the operational changes associated with each of the at least two episodes that did not conform to plant operational rules;
an index value that indicates a difference between an alarm trip point and an actual value of the triggering event;
a duration of time utilized by each of the at least two episodes in order to resolve the similar triggering event; and
a set of operational history related to each of the at least two episodes.

11. The electronic device of claim 9, wherein to generate the causal pairing matrix, the processor is configured to:
detect patterns from the collected information including:
the triggering event associated with the identified episodes,
the operational changes associated with the identified episodes,
a set of operational history associated industrial plant, and
operational rules of the industrial plant associated with the identified episodes; and
derive a probability rating based on the detected patterns, wherein the probability rating indicates whether the personnel will perform one or more operational changes in response to a particular triggering event.

12. The electronic device of claim 9, wherein the processor is further configured to identify a personnel type associated with each of the identified episodes based in part on the triggering event and the operational changes performed, wherein the personnel type is an operator, a maintenance engineer, or a field engineer.

13. The electronic device of claim 9, wherein the triggering event includes at least one of
an alarm that occurs at the industrial plant;
a warning that occurs at the industrial plant;
a maintenance event that occurs at the industrial plant;
a device failure that occurs at the industrial plant;
a programming event that occurs at the industrial plant; and
a violation of an operational rule of the industrial plant.

14. The electronic device of claim 9, wherein the collected information includes operational data, system configuration data, and maintenance logs.

15. The electronic device of claim 9, where the processor is further configured to indicate in the generated report each episode of the at least two episodes that is ranked below a threshold in each of the groups.

16. The electronic device of claim 15, where the processor is further configured to generate a training module, based on the identified bench mark episode, for each of the groups that include at least one episode that is ranked below the threshold, wherein the training module provides a personalized simulation to each personnel associated with the at least one episode ranked below the threshold.

17. A non-transitory computer readable medium embodying a computer program, the computer program comprising computer readable program code that when executed by a processor of an electronic device causes processor to:
collect information associated with operational changes by personnel that operate an industrial plant;
identify episodes of the operational changes, wherein each episode includes a triggering event and the operational changes performed by each of the personnel in response to the triggering event;
generate a causal pairing matrix that categorizes the identified episodes into a plurality of groupings, wherein each of the groups includes at least two episodes that are related based on the triggering event of each of the at least two episodes being similar;
analyze the at least two episodes to identify one of the at least two episodes as a bench mark episode, within each of the groups;
compare each of the at least two episodes to the identified bench mark episode to rank the operational changes performed by each of the personnel of the at least two episodes, within each of the groups; and
generate a report for the plurality of groupings, wherein the report indicates the rank of the at least two episodes in each of the groups.

18. The non-transitory computer readable medium of claim 17, wherein to identify the bench mark episode within each of the groups and to compare each of the at least two episodes to the identified bench mark episode within each of the groups, the computer readable medium further comprising program code that, when executed at the processor, causes the processor to:
evaluate a number of the operational changes performed by the personnel of each of the at least two episodes, to resolve the similar triggering event;
evaluate the operational changes performed by the personnel of each of the at least two episodes, in response to the triggering event;
evaluate the operational changes not performed by the personnel of each of the at least two episodes, in response to the triggering event;
evaluate a quantity of the operational changes associated with each of the at least two episodes that did not conform to plant operational rules;
evaluate an index value that indicates a difference between an alarm trip point and an actual value of the triggering event;
evaluate a duration of time utilized by each of the at least two episodes in order to resolve the similar triggering event; and
evaluate a set of operational history related to each of the at least two episodes.

19. The non-transitory computer readable medium of claim 17, wherein to generate a causal pairing the computer readable medium further comprising program code that, when executed at the processor, causes the processor to:
detecting patterns from the collected information including:
the triggering event associated with the identified episodes,
the operational changes associated with the identified episodes,
a set of operational history associated industrial plant, and
operational rules of the industrial plant associated with the identified episodes; and
deriving a probability rating based on the detected patterns, wherein the probability rating indicates whether the personnel will perform one or more operational changes in response to a particular triggering event.

20. The non-transitory computer readable medium of claim 17, further comprising program code that, when executed at the processor, causes the processor to:
indicate in the generated report each episode of the at least two episodes that is ranked below a threshold in each of the groups; and
generate a training module, based on the identified bench mark episode, for each group that includes at least one episode that is ranked below the threshold, wherein the training module provides a personalized simulation to each personnel associated with the at least one episode ranked below the threshold.
